(19) United States
(12) Patent Application Publication
(10) Pub. No.: US 2007/0194549 A1
(43) Pub. Date: Aug. 23, 2007

(54) Bearing element for a motor vehicle stabilizer

(75) Inventors: Francesco Germano, Bietigheim-Bissingen (DE); Achim Schulz, Niefern-Oeschelbronn (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 11/641,652

(22) Filed: Dec. 20, 2006

(30) Foreign Application Priority Data
Jan. 20, 2006 (DE) 10 2006 002 749.3

(51) Int. Cl. B60G 21/055

(52) U.S. Cl. 280/124.107

(57) ABSTRACT

A bearing element for a motor-vehicle stabilizer, in particular of a vehicle suspension and shock-absorbing system. The bearing element includes two half shells, each of which comprises an inner shell and an outer shell that are connected to one another via an elastic intermediate layer disposed between the respective inner shell and the corresponding outer shell permits a twisting of the inner shell with respect to the outer shells and simultaneously reduces vibration transmission.

### RELATED APPLICATIONS

This application claims priority to German Patent Application Serial No. 10 2006 002 749.3, filed Jan. 20, 2006, the contents of which are incorporated herein by reference.

### BACKGROUND AND SUMMARY OF THE INVENTION

The present invention relates to a bearing element for a stabilizer of a motor vehicle, in particular of a suspension and shock absorbing system.

DE 199 45 044 A1 shows that a bearing element to prevent a stabilizer's lateral displacement is known. For lateral fixation of the stabilizer, an adhesive with an additive suitable for additional vulcanization is applied on an inner surface of a rubber sleeve that is notched at least one point in order to be able to be fastened to the stabilizer. Along with this, the inner sleeve lies on the outer surface of a fixed part of the stabilizer. The outer surface of the inner sleeve is preferably fastened to the stabilizer by a clip, where the inner sleeve and the clip are heated in order to glue the inner sleeve onto the outer surface of the fixed part of the stabilizer. Thereby a significant fixation force against a load in the lateral direction is produced so that a lateral displacement of the stabilizer can be prevented. In so doing, however, fixation of the bearing on the stabilizer is done exclusively via the stated adhesive that, like all adhesives, is subject to a natural aging process and thereby loses fixation power over time.

EP 0 547 945 A1 discloses another bearing element for a stabilizer, in which the bearing element is intended to enable elastic bearing of the stabilizer on a part fixed with respect to the vehicle. This is achieved, for example, by an elastic ring encircling the stabilizer peripherally, which is fastened to the vehicle via clips.

DE 39 21 457 C2 shows a torsion bar for motor vehicles and with legs bent at the ends for connection to bearing parts of the motor vehicle. In connection therewith, a bearing pushed onto the torsion bar and connected thereto is provided between the legs. The bearing is supportable against a counterbearing preventing axial movement between the bearing and torsion bar, and the counterbearing is fixed in a form-locking manner on the torsion bar. In order to realize the form lock, one or more catch elements formed as raised areas are provided locally on the inner circumferential surface of the hole of the counterbearing. The catch elements engage in corresponding indentations provided in the torsion bar. The disadvantage presents itself, however, by the fact that the torsion bar is weakened in its cross section in the area of the indentations.

An object of the present invention is to solve the problem of specifying an improved form of embodiment for a bearing element for a known-type of stabilizer such that the bearing element permits, on the one hand, simple mounting and, on the other hand, a reliable bearing of the stabilizer on the motor vehicle.

This object has been achieved according to the invention by forming a motor vehicle stabilizer bearing element from two half shells that, in a simple manner, can be mounted on the stabilizer in the radial direction and connected thereto. Each of the two half shells has both an inner shell and an outer shell, between which an elastic intermediate layer is disposed that, on one hand, connects the respective outer shell to the respective corresponding inner shell and, on the other hand, permits a certain, elastic, i.e., springy, twisting movement between the respective inner shell and the corresponding outer shell.

By forming the bearing element with two half shells, the mounting of the bearing element can clearly be simplified, whereby the mounting effort, and the mounting costs associated therewith, can be reduced. Moreover, by disposing the elastic intermediate layer between the respective outer shell and the corresponding inner shell, an elastic, but at the same time reliable, bearing of the stabilizer on the motor vehicle is achieved.

In a currently preferred form of the present invention, each of the inner shells comprises a recess open towards the stabilizer. The recess is formed so as to be complementary to a collar disposed so that it projects out on the stabilizer. In this connection, the recess in the mounted state can form an inner polygon, e.g., an inner hexagon, with the collar as an outer polygon, e.g., an outer hexagon, that fits (i.e., is formed so as to be complementary to) the inner polygon. With the recess a form-locking and force-locking connection of the respective inner shells to the stabilizer can be achieved, where, moreover, it is contemplated that the collar and the corresponding recesses are formed so that only one possible mounting position results, whereby incorrect mounting of the bearing element on the stabilizer can be avoided.

Moreover, with the collar disposed so that it projects out on the stabilizer, a torque of the stabilizer can be transferred to the bearing element or the bearing element's inner shells, that pass the torque on to the elastic intermediate layer. The elastic intermediate layer permits turning the inner shells with respect to the two outer shells so that the bearing element can compensate any turning movements of the stabilizer. Moreover, the stabilizer can be fixed via its collar which is disposed to project out and engage in the recesses of the two inner shells in a form-locking manner both in the axial direction and in the radial direction. In particular, an axial fixation has been realized only with difficulty in prior-art bearing elements for stabilizers.

Advantageously, the elastic intermediate layer is made of plastic or rubber and is mechanically connected to the respective outer shell on one side and the respective inner shell on the other side, e.g., by vulcanizing, gluing, welding, or spraying. Rubber and plastics are favorable and tested materials, and can be connected to other components by the stated processes in a manner that is simple and economical from a manufacturing technology standpoint.

Also advantageously, a clamping element encloses the two inner shells of the bearing element and clamps them against the stabilizer. A clamping element of this type can, for example, be shaped in the form of a clip, in particular a commercially available hose clip, and thereby reliably secures the hold of the two inner shells of the bearing element on the stabilizer and in addition can be attached, and detached once again, in a simple manner.

At the same time a clamping clip of the aforementioned type offers the great advantage that it is an economical fastening element which is available in nearly any form of embodiment. In order to be able to fix the clamping element with respect to its position relative to the two inner shells of the bearing element, the respective inner shells can comprise, on the outside in the area of the recess open towards the stabilizer, a groove in which the clamping element is disposed so that it engages around the two inner shells of the bearing element. A groove of this type can, for example, have a width equal to, or minimally greater than, the width of the clamping element so that it can be disposed so as to fit precisely in the groove. Such a groove additionally simplifies the mounting of the clamping element and fixes the clamping element with respect to its position relative to the two inner shells of the bearing element also in those cases in which the clamping element is not held in position solely by its clamping force.

### BRIEF DESCRIPTION OF THE DRAWINGS

Other objects, advantages and novel features of the present invention will become apparent from the following detailed description of the invention when considered in conjunction with the accompanying drawings, in which:

FIG. 1 is a schematic partial cross-sectional view of a bearing element according to the present invention shown mounted on a stabilizer of a motor vehicle; and

FIG. 2 is a perspective view of a half shell of the bearing element according to the present invention.

### DETAILED DESCRIPTION OF THE DRAWINGS

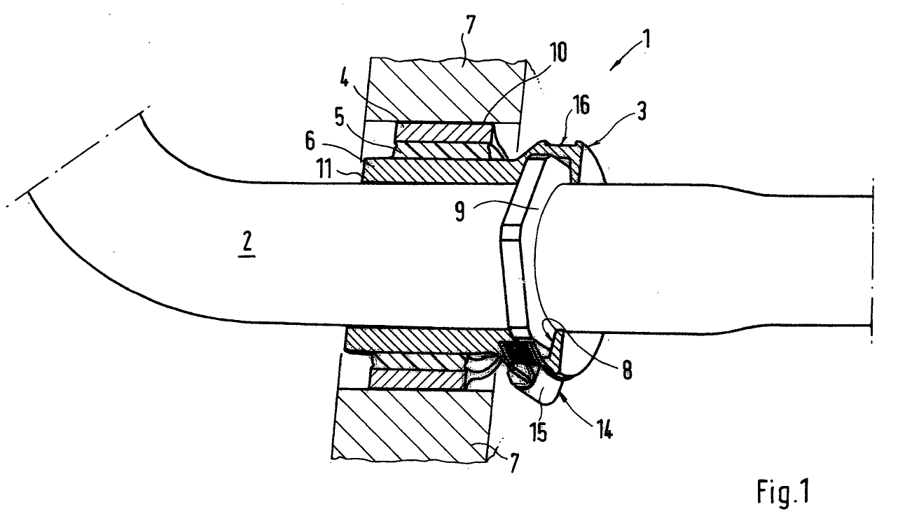

As seen in FIG. 1 a bearing element designated generally by numeral 1 according to the present invention used for a stabilizer 2 of a motor vehicle includes two half shells 3, 3′. FIG. 1 shows only the one half shell 3 for sake of simplicity and understanding particularly as the shells are identical in construction. The stabilizer 2 is part of a known-type of suspension and shock-absorbing system (not shown), and effects a compensation of two vehicle wheels with respect to their inward or outward spring travel.

The half shell of the bearing element 1 is made of multiple shells, where an outer shell 4 is connected, via an intermediate layer 5 and in an elastic manner, to an inner shell 6.

The outer shell 4 and the inner shell 6 of the respective half shell 3 and 3′ can be made of rust-resistant metal, in particular aluminum, that also has low weight which is of great advantage in sports cars in particular. Also contemplated are, of course, other metallic materials and/or plastics.

FIG. 1 shows the bearing element 1 as mounted on the stabilizer 2, where the inner shell 6 of the half shell 3 is connected in a form-locking and/or force-locking manner to the stabilizer 2 and the outer shell 4 is connected in a form-locking and/or force-locking manner to a body component 7 of the motor vehicle. The form or force lock of the inner shell 6 on the stabilizer 2 is effected via a recess 8 open towards the stabilizer 2. The recess 8 is formed to be complementary to a collar 9 disposed, so that it projects out on or from the stabilizer 2. In this connection, the recess 8 preferably forms in each half shell 3 and 3′ an inner polygon, in particular an inner hexagon, while the collar 9 is formed as an outer polygon, in particular an outer hexagon, complementary in configuration to the inner polygon. In the embodiment shown in FIG. 1 the collar 9 is formed as an outer double hexagon while the recess 8 on the half shell 3 is formed as an inner double hexagon. It is also contemplated, however, that the recess 8 on the half shell 3 is formed as an inner hexagon and the outer polygon has the form shown in FIG. 1 so that there is also a force-locking connection between the collar 9 and the recess 8 of the inner shells 3 and 3′. In this case, the collar 9 is generally formed on the stabilizer 2, e.g., by swaging, where it is also contemplated that a collar 9 is subsequently disposed on the stabilizer 2 and then connected in a fixed manner to the stabilizer 2.

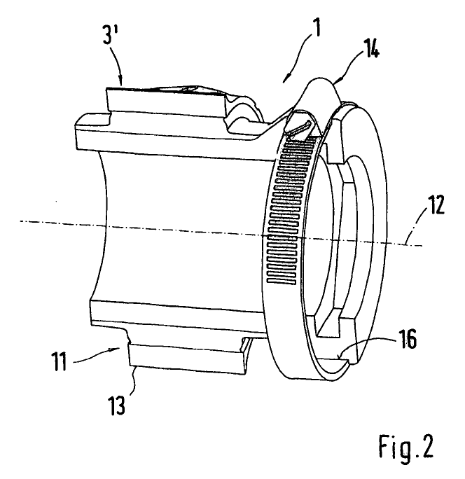

Preferably, the recess 8 is adapted to the collar 9 so that only one possible mounting position of the two inner shells 6 of the bearing element 1 results whereby incorrect mounting of the bearing element 1 on the stabilizer 2 is eliminated. Moreover, the embodiment of the bearing element 1 shown in FIGS. 1 and 2 is merely to be understood as purely exemplary so that the invention will also encompass other forms that comprise two half shells 3, 3′ and where each half shell 3, 3′ comprises an outer shell 4, an intermediate layer 5, and an inner shell 6.

Similar to the manner by which the recess 8 on the inner shell 6 of the half shell 3 enters into a force-locking or form-locking connection to the collar 9, a corresponding outer contour (not shown) can also be provided on the outer surface 10 of the outer shell 4. This outer contour works together with inner counter contours on the body component 7, and the inner counter contours are formed complementary to the outer contours. In this case it is further contemplated in particular that a contour 13 projecting outwards in the radial direction with respect to the bearing element axis 12 as seen in FIG. 2 is formed on a separating surface 11 of the two half shells 3 and 3′, with the contour engaging, to secure against turning, in a counter contour (not shown) formed on the body component 7 but not shown.

The elastic intermediate layer 5 that, for example, is made of plastic or rubber permits turning of the inner shell 6 with respect to the outer shell 4. In this connection, the intermediate layer 5 is formed so that, under normally occurring torques, it does not detach from the outer shell 4 or from the inner shell 6. It is also contemplated to produce a connection of the intermediate layer 5 to the respective corresponding outer shell 4 or inner shell 6 of the respective half shell 3 or 3′, for example, by vulcanizing, gluing, welding, or spraying. All these processes are suitable to reliably connect the elastic intermediate layer 5 permanently to the outer shell 4 as well as to the inner shell 6.

According to FIGS. 1 and 2, the elastic intermediate layer 5 runs only over a part of the axial extension of the bearing element 1, where the recess 8 open towards the stabilizer 2 is disposed on the respective inner shell 6 of the respective half shell 3, 3′ so as to be adjacent, in the axial direction, to the intermediate layer 5. Moreover, the respective outer shell 4 of the respective half shell 3, 3′ has essentially the same axial extension as the corresponding elastic intermediate layer 5. The elastic intermediate layer 5 can be adapted with respect to its radial thickness or its axial longitudinal extension to respective requirements, i.e., when high torques are to be absorbed it has a greater axial longitudinal extension than when lower torques are to be absorbed. Overall, the elastic intermediate layer 5 acts as a torsion spring which works against the torque transferred to the inner shell 6 by the stabilizer 2.

For fastening the bearing element 1 to the stabilizer 2, a clamping element 14 engages around or encloses the two inner shells 6 of the bearing element 1 and clamps them against the stabilizer 2. As the clamping element 14, a clip 15, for example, and in particular a hose clip, can be used. The clip first has the capacity to apply the required clamping force without difficulty and second is economical.

In order to fix the clamping element 14 with respect to its position relative to the inner shell 6, the respective inner shells 6 can comprise, on the outside in the area of the recess 8 open towards the stabilizer 2, a groove 16 running in the circumferential direction. In so doing, this groove 16 preferably has a slightly greater width than the clamping element 14 so that it can engage with a precise fit in the groove 16.

As shown in FIGS. 1 and 2, the clamping element 14 is disposed on the inner shells 6 on the outside in the area of the recess 8 open towards the stabilizer 2 in the groove 16 there. For clamping the inner shells 6 against the stabilizer 2, the clip 15 is bent by way of a screwdriver so that its circumference is shortened which causes a pressing of the inner shells 6 against the stabilizer 2.

With the bearing element 1 according to the present invention, a particularly simple and quick mounting of the same on the stabilizer 2 can be achieved and at the same time the bearing element 1 according to the invention can be produced economically. Any transfer of vibrations either from the body element 7 to the stabilizer 2 or vice versa is effectively prevented by the elastic intermediate layer 5, where the elastic intermediate layer 5 furthermore has the advantage that it can absorb a certain turning of the stabilizer 2 without the inner shells 6 detaching from the stabilizer 2 or the outer shells 4 from the body element 7.

In summary, the present invention forms a bearing element 1 for a stabilizer 2 of a motor vehicle as two shells, i.e., of two half shells 3 and 3′. Each half shell 3 and 3′ comprises an outer shell 4, an intermediate layer 5, and an inner shell 6. The intermediate layer 5 is, in comparison to the outer shell 4 and the inner shell 6, elastic and, first, reduces any transfer of vibrations from the stabilizer 2 to the body element 7 or vice versa and, second, permits a certain turning, about the axis 12 of the bearing element, of the inner shell 6 relative to the outer shell 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Bearing element for a motor vehicle stabilizer such as is used in a suspension and shock-absorbing system, comprising two half shells, each of which half shell comprises an inner shell and an outer shell operatively connected via an elastic intermediate layer disposed therebetween.

2. Bearing element according to claim 1, wherein at least one of the inner shells in a mounted state are connected in at least one of form-lockingly and force-lockingly to the stabilizer and the outer shells in the mounted state are connected in at least one of a form-lockingly and force-lockingly to the motor vehicle.

3. Bearing element according to claim 1, wherein at least one of the elastic intermediate layer is plastic or rubber, the elastic intermediate layer is one of vulcanized, glued, welded, and sprayed onto the respective outer shell on one side and the respective inner shell on the other side, and at least one of the inner shells and the outer shells are aluminum.

4. Bearing element according to claim 3, wherein at least one of the inner shells in a mounted state are connected in at least one of form-lockingly and force-lockingly to the stabilizer and the outer shells in the mounted state are connected in at least one of a form-lockingly and force-lockingly to the motor vehicle.

5. Bearing element according to claim 1, wherein at least one of each of the inner shells comprises a recess open towards the stabilizer, said recess being formed so as to be complementary to a collar disposed, to project out on the stabilizer and the recesses in a mounted state form an inner polygon, and the collar is formed as an outer polygon complementary to the inner polygon.

6. Bearing element according to claim 5, wherein the recesses and collar have complementary hexagonal shapes, said recesses formed as inner hexagons and outer hexagons and said collar being an outer hexagon.

7. Bearing element according to claim 5, wherein at least one of the elastic intermediate layer extends only partially over an axial extension of the bearing element, the recess open towards the stabilizer is disposed on the respective inner shell so as to be adjacent, in an axial direction thereof, to the intermediate layer, and the respective outer shell has essentially the same axial extension as the corresponding elastic intermediate layer.

8. Bearing element according to claim 1, wherein at least one of a clamping element encloses the two inner shells of the bearing element and is configured to clamp the two inner shells against the stabilizer, the respective inner shells comprise, on the outside in the area of the recess open towards the stabilizer, a groove, the clamping element is disposed on the respective inner shell on the outside in the area of the recess open towards the stabilizer, or in the groove, and the clamping element is a clip.

9. Bearing element according to claim 8, wherein at least one of the inner shells in a mounted state are connected in at least one of form-lockingly and force-lockingly to the stabilizer and the outer shells in the mounted state are connected in at least one of a form-lockingly and force-lockingly to the motor vehicle.

10. Bearing element according to claim 9, wherein at least one of the elastic intermediate layer is plastic or rubber, the elastic intermediate layer is one of vulcanized, glued, welded, and sprayed onto the respective outer shell on one side and the respective inner shell on the other side, and at least one of the inner shells and the outer shells are aluminum.

11. Bearing element according to claim 8, wherein at least one of each of the inner shells comprises a recess open towards the stabilizer, said recess being formed so as to be complementary to a collar disposed, to project out on the stabilizer and the recesses in a mounted state form an inner polygon, and the collar is formed as an outer polygon complementary to the inner polygon.

12. Bearing element according to claim 11, wherein at least one of the elastic intermediate layer extends only partially over an axial extension of the bearing element, the recess open towards the stabilizer is disposed on the respective inner shell so as to be adjacent, in an axial direction thereof, to the intermediate layer, and the respective outer shell has essentially the same axial extension as the corresponding elastic intermediate layer.
